(19) United States
(12) Patent Application Publication
(10) Pub. No.: US 2013/0059141 A1
(43) Pub. Date: Mar. 7, 2013

(54) FOAMS COMPRISING POLYPROPYLENE CARBONATE

(71) Applicants: Andreas Füßl, Heidelberg (DE); Jan Kurt Walter Sandler, Heidelberg (DE); Sameer Nalawade, Mannheim (DE); Tobias Heinz Steinke, Speyer (DE); Volker Warzelhan, Weisenheim Am Berg (DE); Andreas Künkel, Neustadt (DE); Klaus Hahn, Kirchheim (DE); Jerome Lohmann, Landau (DE); Anna Katharina Brym, Limburgehof (DE)

(72) Inventors: Andreas Füßl, Heidelberg (DE); Jan Kurt Walter Sandler, Heidelberg (DE); Sameer Nalawade, Mannheim (DE); Tobias Heinz Steinke, Speyer (DE); Volker Warzelhan, Weisenheim Am Berg (DE); Andreas Künkel, Neustadt (DE); Klaus Hahn, Kirchheim (DE); Jerome Lohmann, Landau (DE); Anna Katharina Brym, Limburgehof (DE)

(73) Assignee: BASF SE, Ludwigshafen (DE)

(21) Appl. No.: 13/602,870

(22) Filed: Sep. 4, 2012

Related U.S. Application Data
(60) Provisional application No. 61/530,421, filed on Sep. 2, 2011.

(51) Int. Cl. C08L 67/00; E04B 1/74; C08L 67/02; C08J 9/08; C08K 3/20

(52) U.S. Cl. 428/220; 521/134; 521/133; 521/138; 252/62

(57) ABSTRACT

The present invention relates to foam layers based on a biodegradable polyester mixture PM, comprising:
i) from 5 to 49% by weight, based on the total weight of components i to ii, of at least one polypropylene carbonate;
ii) from 51 to 95% by weight, based on the total weight of components i to ii, of polylactic acid;
iii) from 0 to 25% by weight, based on the total weight of components i to v, of a polyester composed of an (x1) aliphatic and/or (x2) aromatic dicarboxylic acid and of an (y) aliphatic diol;
iv) from 0 to 5% by weight, based on the total weight of components i to v, of a copolymer which comprises epoxy groups and which is based on styrene, acrylate, and/or methacrylate; and
v) from 0 to 15% by weight, based on the total weight of components i to v, of additives.

The present invention relates to foam layers based on a biodegradable polyester mixture PM, comprising
i) from 5 to 49% by weight, based on the total weight of components i to ii, of at least one polypropylene carbonate;
ii) from 51 to 95% by weight, based on the total weight of components i to ii, of polylactic acid;
iii) from 0 to 25% by weight, based on the total weight of components i to v, of a polyester composed of an (x1) aliphatic and/or (x2) aromatic dicarboxylic acid and of an (y) aliphatic diol;
iv) from 0 to 5% by weight, based on the total weight of components i to v, of a copolymer which comprises epoxy groups and which is based on styrene, acrylate, and/or methacrylate; and
v) from 0 to 15% by weight, based on the total weight of components i to v, of additives.

The present invention further relates to foam layers based on a biodegradable polyester mixture, comprising:
i) from 5 to 45% by weight, based on the total weight of components i and ii, of at least one polypropylene carbonate;
ii) from 55 to 95% by weight, based on the total weight of components i to ii, of polylactic acid;
iii) from 1 to 25% by weight, based on the total weight of components i to v, of a polyester composed of an (x1) aliphatic and/or (x2) aromatic dicarboxylic acid and of an (y) aliphatic diol;
iv) from 0.05 to 2% by weight, based on the total weight of components i to v, of a copolymer which comprises epoxy groups and which is based on styrene, acrylate, and/or methacrylate; and
v) from 0.1 to 5% by weight, based on the total weight of components i to v, of additives.

The present invention further relates to a process for producing the foam layers mentioned, and to the use of the foam layers for thermal insulation and sound-deadening, or else as packaging material.

Polyester mixtures comprising polypropylene carbonate are known from WO 2007/0125039. That document does not describe the production of foam layers.

It is difficult to process polypropylene carbonate itself on an industrial scale to give foams (see J. Jiao et al., Journal of Applied Polymer Science, Vol. 102, 2006 5240-47). Foams with very high density are obtained (see comparative examples 1 and 2).

Mixtures of polypropylene carbonate and aliphatic-aromatic polyesters—as described in WO 2010/034689—already give better results. However, the densities are still not always entirely satisfactory (see comparative examples 3 and 4).

The polyester mixtures known from the prior art have only restricted suitability for producing foam layers. In particular, it has not hitherto been possible to produce any foam layers of low density in particular smaller than 200 g/l, particularly preferably smaller than 100 g/l, particularly preferably smaller than 50 g/l.

The present invention is therefore based on the object of providing foam layers made of biodegradable materials, with low density.

Surprisingly, it has now been found that polyester mixtures comprising:
i) from 5 to 49% by weight, based on the total weight of components i to ii, of at least one polypropylene carbonate;
ii) from 51 to 95% by weight, based on the total weight of components i to ii, of polylactic acid;
iii) from 0 to 25% by weight, based on the total weight of components i to v, of a polyester composed of an (x1) aliphatic and/or (x2) aromatic dicarboxylic acid and of an (y) aliphatic diol;
iv) from 0 to 5% by weight, based on the total weight of components i to v, of a copolymer which comprises epoxy groups and which is based on styrene, acrylate, and/or methacrylate; and
v) from 0 to 15% by weight, based on the total weight of components i to v, of additives;
   can be processed with blowing agents, such as in particular carbon dioxide or nitrogen, to give foam layers with low density.

The stability of the foam could moreover be improved through the use of preferably from 0.05 to 2% by weight, based on the total weight of components i to v, of a copolymer which comprises epoxy groups and which is based on styrene, acrylate and/or methacrylate (component iv).

Finally, for formation of fine-cell foam, it has proven advantageous to add preferably from 0.2 to 3% by weight, based on the total weight of components i to v, of a nucleating agent (component v), such as talc powder or chalk.

The polypropylene carbonate (component i) can be produced by analogy with, for example, WO 2003/029325, WO2006/061237 or WO 2007/125039 via copolymerization of propylene oxide and carbon dioxide.

The polypropylene carbonate chain can comprise not only ether groups but also carbonate groups. The proportion of carbonate groups in the polymer depends on the reaction conditions, such as in particular the catalyst used. In the preferred polypropylene carbonates, more than 85%, and preferably more than 90%, and with particular preference more than 95%, of all of the linkages are carbonate groups. Suitable zinc catalysts and cobalt catalysts are described in U.S. Pat. No. 4,789,727 and U.S. Pat. No. 7,304,172. Polypropylene carbonate can moreover be produced by analogy with Soga et al., Polymer Journal, 1981, 13, 407-10. The polymer is also available commercially and is marketed by way of example by Empower Materials Inc. or Aldrich. Recently, polypropylene carbonates having almost 100% polycarbonate content and having a high proportion of head/tail linkages have been developed by companies such as SK Energy and Novomer (see WO 2010013948, WO2010028362 and WO2010022388). These products are in particular preferred for the foam layers of the invention.

The molecular weight Mn of the polypropylene carbonates produced by the abovementioned processes is generally from 70 000 to 90 000 daltons. The molecular weight Mw is usually from 250 000 to 400 000 daltons.

Polypropylene carbonates with Mn below 20 000 daltons usually have low glass transition temperatures below 20° C. Polydispersity (ratio of weight average (Mw) to number average (Mn)) is generally from 1 to 80 and preferably from 2 to 10. These polypropylene carbonates can comprise up to 1% of carbamate groups and urea groups.

Particular chain extenders used for the polypropylene carbonates are maleic anhydride, acetic anhydride, di- or polyisocyanates, di- or polyoxazolines or -oxazines, or di- or polyepoxides. Examples of isocyanates are tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate, and xylylene diisocyanate, and in particular hexamethylene 1,6-diisocyanate, isophorone diisocyanate, and methylenebis(4-isocyanatocyclohexane). Particularly preferred aliphatic diisocyanates are isophorone diisocyanate and in particular hexamethylene 1,6-diisocyanate. Bisoxazolines that may be mentioned are 2,2′-bis(2-oxazoline), bis(2-oxazolinyl)methane, 1,2-bis(2-oxazolinyl)ethane, 1,3-bis(2-oxazolinyl)propane, and 1,4-bis(2-oxazolinyl)butane, and in particular 1,4-bis(2-oxazolinyl)benzene, 1,2-bis(2-oxazolinyl)benzene, and 1,3-bis(2-oxazolinyl)benzene. The amounts preferably used of the chain extenders are from 0.01 to 5% by weight, preferably from 0.05 to 2% by weight, particularly preferably from 0.08 to 1% by weight, based on the amount of polymer.

If a polypropylene carbonate having from 6 to 25% by weight polyether content is used instead of polypropylene carbonate having less than 5% by weight polyether content, the glass transition temperature Tg decreases to levels as low as 1° C.

Preference is given to polylactic acid with the following property profile as components ii of the biodegradable polyester mixtures:

melt volume rate (MVR for 190° C. and 2.16 kg to ISO 1133) of from 0.5 to 9 ml/10 minutes, preferably from 2 to 9 ml/10 minutes;
melting point below 175° C.;
glass transition temperature (Tg) above 55° C.;
water content smaller than 1000 ppm;
residual monomer content (L-lactide) smaller than 0.3%;
molecular weight greater than 80 000 daltons.

An example of a preferred component ii is NatureWorks® 4020 or 4043D (polylactide from NatureWorks).

In principle, the production of the biodegradable polyester mixtures of the invention can use, as component iii, any of the polyesters based on aliphatic and aromatic dicarboxylic acids and on aliphatic dihydroxy compound, known as semiaromatic polyesters. Mixtures of a plurality of these polyesters are, of course, also suitable as component iii.

In the invention, the expression semiaromatic polyesters is also intended to cover polyester derivatives, such as polyetheresters, polyesteramides, and polyetheresteramides. Among the suitable semiaromatic polyesters are linear non-chain-extended polyesters (WO 92/09654). Preference is given to chain-extended and/or branched semiaromatic polyesters. The latter are known from the specifications mentioned in the introduction, WO 96/15173 to 15176, 21689 to 21692, 25446, 25448, or WO 98/12242, expressly incorporated herein by way of reference. Mixtures of different semiaromatic polyesters can equally be used. The expression semiaromatic polyesters in particular means products such as Ecoflex® (BASF SE), Eastar® Bio, and Origo-Bi (Novamont).

In one preferred embodiment, acid component x of the semiaromatic polyesters comprises from 30 to 70 mol %, in particular from 40 to 60 mol %, of aliphatic dicarboxylic acid x1 and from 30 to 70 mol %, in particular from 40 to 60 mol %, of aromatic dicarboxylic acid x2.

Aliphatic acids and the corresponding derivatives x1 that can be used are generally those having from 2 to 16 carbon atoms, preferably from 4 to 6 carbon atoms. They can be either linear or branched. The cycloaliphatic dicarboxylic acids that can be used for the purposes of the present invention are generally those having from 7 to 10 carbon atoms, and in particular those having 8 carbon atoms. However, it is also possible in principle to use dicarboxylic acids having a larger number of carbon atoms, for example having up to 30 carbon atoms.

Examples that may be mentioned are: malonic acid, succinic acid, glutaric acid, 2-methylglutaric acid, 3-methylglutaric acid, adipic acid, pimelic acid, azelaic acid, sebacic acid, fumaric acid, 2,2-dimethylglutaric acid, suberic acid, 1,3-cyclopentanedicarboxylic acid, 1,4-cyclohexanedicarboxylic acid, 1,3-cyclohexanedicarboxylic acid, diglycolic acid, itaconic acid, maleic acid, brassylic acid, and 2,5-norbornanedicarboxylic acid.

The dicarboxylic acids or ester-forming derivatives of these can be used individually here or in the form of a mixture of two or more thereof.

Preference is given to succinic acid, adipic acid, azelaic acid, sebacic acid, and brassylic acid.

An aromatic dicarboxylic acid x2 that may be mentioned is in general any of those having from 8 to 12 carbon atoms and preferably any of those having 8 carbon atoms. Terephthalic acid may be mentioned as an example.

The diols y are generally selected from branched or linear alkanediols having from 2 to 12 carbon atoms, preferably from 4 to 6 carbon atoms, or from cycloalkanediols having from 5 to 10 carbon atoms. Particular preference is given to 1,4-butanediol and 1,3-propanediol.

Polyester component iii can comprise, alongside components x and y, further components, such as branching agents or chain extenders.

The following aliphatic-aromatic polyesters are in particular preferred as component iii: polybutylene adipate terephthalate (PBAT), polybutylene sebacate terephthalate (PBSeT), and polybutylene succinate terephthalate (PBST), and aliphatic polyesters, such as polybutylene succinate (PBS), polybutylene adipate (PBA), polybutylene succinate adipate (PBSA), polybutylene succinate sebacate (PBSSe), and polybutylene sebacate (PBSe).

For the purposes of the present invention, compliance with the “biodegradable” feature is achieved for a substance or a substance mixture when the percentage degree of biodegradation of said substance or of the substance mixture is at least 60% in at least one of the three processes defined in DIN V 54900-2 (preliminary standard, as at September 1998).

Biodegradation generally leads to decomposition of the polyesters or polyester mixtures in an appropriate and demonstrable period of time. The degradation can take place by an enzymatic, hydrolytic, or oxidative route, and/or via exposure to electromagnetic radiation, such as UV radiation, and can mostly be brought about predominantly via exposure to microorganisms, such as bacteria, yeasts, fungi, and algae. Biodegradability can be quantified by way of example by mixing the polyester with compost and storing it for a particular period. By way of example in DIN EN 13432 (referring to ISO 14855), CO₂-free air is passed through ripened compost during the composting process, and the compost is subjected to a defined temperature profile. Biodegradability here is defined as a percentage degree of biodegradation, by taking the ratio of the net amount of CO₂ released from the specimen (after subtraction of the amount of CO₂ released by the compost without specimen) to the maximum amount of CO₂ that can be released from the specimen (calculated from the carbon content of the specimen). Biodegradable polyesters or biodegradable polyester mixtures generally exhibit clear signs of degradation after just a few days of composting, examples being fungal growth, cracking, and perforation.

Other methods of determining biodegradability are described by way of example in ASTM D 5338 and ASTM D 6400-4.

Component IV is a copolymer which comprises epoxy groups and which is based on styrene, acrylate, and/or methacrylate, and which has the following structural features. The units bearing epoxy groups are preferably glycidyl (meth)acrylates. Copolymers that have proven advantageous have more than 20% by weight glycidyl methacrylate content, particularly preferably more than 30% by weight, and with particular preference more than 50% by weight, based on the copolymer. The epoxy equivalent weight (EEW) in said polymers is preferably from 150 to 3000 g/equivalent, and with particular preference from 200 to 500 g/equivalent. The average molecular weight (weight average) MW of the polymers is preferably from 2000 to 25 000, in particular from 3000 to 8000. The number-average molecular weight Mn of the polymers is preferably from 400 to 6000, in particular from 1000 to 4000. Polydispersity (Q) is generally from 1.5 to 5. Copolymers of the abovementioned type comprising epoxy groups are marketed by way of example as Joncryl® ADR by BASF Resins B.V. Particularly suitable chain extenders are Joncryl® ADR 4368 and Cardura® E10 from Shell.

Amounts used of copolymers of the abovementioned type comprising epoxy groups are from 0 to 5% by weight, preferably from 0.05 to 2% by weight, and particularly preferably from 0.1 to 1% by weight, based on components i to v.

Among the additives v) are by way of example:
nucleating agents, such as talc powder, chalk, carbon black, graphite, calcium stearate or zinc stearate, poly-D-lactic acid, N,N′-ethylenebis-12-hydroxystearamide, polyglycolic acid,
lubricants and antiblocking agents,
waxes,
antistatic agents,
other compatibilizers, such as silanes, maleic anhydride, fumaric anhydride, isocyanates, diacyl chlorides,
antifogging agents,
UV stabilizers, and
dyes.

These auxiliaries are in particular used at a concentration of from 0 to 15% by weight, in particular from 0.2 to 3% by weight, based on the total weight of components i to v.

Addition of nucleating agents is particularly advantageous and has an advantageous effect during the production of the foam layers. The finely dispersed nucleating agent provides a surface for cell formation, possible results being achievement of a homogeneous cell structure and control of foam density.

Other materials preferably used as component v) are natural oils comprising epoxy groups or unsubstituted natural oils, fatty acid esters, or fatty acid amides, such as erucamide, or Merginat® ESBO.

Particular organic fillers v) that have proven successful are polymers of renewable raw materials, e.g. starch, starch derivatives, cereals, cellulose derivatives, polycaprolactone, and polyhydroxyalkanoates, and in particular here starch, polyhydroxybutyrate (PHB), polyhydroxybutyrate-co-valerate (PHBV), Biocycle® (polyhydroxybutyrate from PHB Ind.); and Enmat® (polyhydroxybutyrate-co-valerate from Tianan).

Inorganic fillers v) that have proven successful are the following materials previously mentioned as nucleating agents: talc powder, chalk, carbon black, and graphite. However, they can be used in relatively high concentrations as filler. The organic and inorganic fillers can be used at a concentration up to 35% by weight.

The biodegradable polyester mixtures in the foam layers of the invention usually comprise from 5 to 49% by weight, preferably from 5 to 45% by weight, particularly preferably from 10 to 30% by weight, of component i, and from 51 to 95% by weight, preferably from 55 to 95% by weight, particularly preferably from 70 to 90% by weight, of polylactic acid (component ii).

The abovementioned polymer mixtures can be used to obtain foam layers with very low density, which is preferably below 50 g/l, together with excellent haptic properties (see inventive examples 5 to 7).

Another preferred embodiment is based on ternary mixtures of component i (PPC), component ii (polylactic acid), and component iii (aliphatic or semiaromatic polyester). Polyester mixtures of this type preferably comprise from 0 to 25% by weight, with preference from 1 to 25% by weight, and with particular preference from 5 to 20% by weight, of component iii, where the percentages by weight are always based on the total weight of components i to v.

The amount used of component iv is from 0 to 5% by weight, preferably from 0.05 to 2% by weight, and particularly preferably from 0.1 to 1% by weight, based on the total weight of components i to v.

The biodegradable polyester mixtures of the invention can be produced from the individual components by known processes (EP 792 309 and U.S. Pat. No. 5,883,199).

By way of example, all components i to v can be mixed and reacted in a process step in the mixing apparatuses known to the person skilled in the art, for example an autoclave, or in a mold cavity, or in an extruder, at elevated temperatures, for example from 120° C. to 250° C.

The process described in WO 2007/0125039 can moreover be utilized to produce the biodegradable polyester mixtures. The compounding process is generally carried out at from 150 to 250° C.—preferably at from 180 to 200° C.

To produce the extruded foams, the components are mixed in a single- or twin-screw extruder at from 160 to 220° C. A homogeneous blend is obtained at these temperatures.

From 1 to 25% by weight, preferably from 1 to 15% by weight, of blowing agent is introduced into the melt. It is preferable to use physical blowing agents in order to ensure low foam density. Examples of suitable blowing agents are linear alkanes having preferably from 4 to 6 carbon atoms, nitrogen, carbon dioxide, ethanol, dimethyl ether, diethyl ether, methyl ethyl ether, and also combinations thereof. Particular preference is given to butane, pentane, nitrogen, and carbon dioxide, and in particular to physical blowing agents, such as nitrogen or carbon dioxide. The melt loaded with blowing agent is then cooled in a second extruder. As an alternative to this, the cooling process can be carried out in a downstream segment of the compounding extruder. Care has to be taken that, at the selected temperatures, the pressure in the extruder is sufficiently high to suppress any potential premature foaming in the extruder. If a perforated die is used, the product is foam strands with a smooth, lustrous surface.

As an alternative to this, an annular die can be used in order to obtain tubular foam layers. The extruded tubular foam layers are cooled, for example with air, and cut by a blade, and the resultant smooth foam layers are rolled up on a roll. Care has to be taken here to use a constant roll-off speed. The density of the foam can be influenced via the wind-off speed during the extrusion and wind-up process, care also has to be taken that the thickness distribution of the foam foils is homogeneous, since this is of decisive importance for the optional subsequent thermoforming process.

The extruded foam layers can be heated in a thermoforming apparatus via brief and uniform heating by way of example with an infrared heat source from 80 to 120° C., particularly preferably from 90 to 100° C., and thermoformed in a mold to give a defined shape of a foam shell, optionally with additional use of compressed air, and then by way of example can be cooled with air.

One particular application sector for the biodegradable polyester mixtures with reduced oil absorption and reduced water absorption relates to the use for producing foam layers, for providing foamed packaging, for example thermoformed packaging for food or drink.

### EXAMPLES

### Performance Tests:

The melting points of the semiaromatic polyesters were determined via DSC tests using a Seiko Exstar DSC 6200R:

From 10 to 15 mg of the respective specimens were heated under nitrogen at a heating rate of 20° C./min, from −70° C. to 200° C. The melting points stated for the specimens were the peak temperatures of the melting peak observed here. An empty specimen crucible was always used as reference.

The homogeneity of the mixtures of components i, ii, and optionally iii to v, and also of the mixtures produced for comparison, was determined by pressing each of said mixtures at 190° C. to give foils of thickness 30 μm. The proportion of undispersed component ii present in these foils was assessed visually.

Each of the biodegradable polyester mixtures was used to produce foam layers of thickness from 2 to 3 mm via extrusion and use of an annular die.

Density was determined by weighing the foam specimen and determining the displacement volume in water.

### Materials Used:

### Component i (PPC):

i-1: Polypropylene carbonate i-1 was produced by analogy with example 1 of WO 2006/061237 (Tg=35° C.), and was applied in the form of granulated material to the heated (from 100 to 200° C.) contrarotating rollers of the roll system, and heated.

### Component ii (PLA):

ii-1: Aliphatic polyester, Natureworks® 4043D polylactide from NatureWorks.

### Component iii (PBAT)

iii-1: Ecoflex® FBX 7011 from BASF SE

### Component v

v-1: Masterbatch comprising 90% by weight of component iii-1 and 10% by weight of erucamide

### Foam Production:

The biodegradable polyester mixtures stated in the examples below were pressed in a brass mold at the stated temperatures in a heated press using a force of 50 kN, to give a sheet of thickness 1.5 mm. After cooling, the sheet specimen, in a brass shell, at the stated constant temperature, was exposed for a period of 24 h to supercritical CO₂ at a pressure of 200 bar, in a steel pressure vessel (internal volume 30 ml). During this process the specimens absorbed the concentration of blowing gas corresponding to achievable saturation under these experimental conditions.

The specimens saturated with CO₂ and controlled to homogeneous temperature were foamed at the set temperature via rapid pressure decrease; the depressurization took place via rapid manual opening of an outlet valve of the autoclave. Directly after foaming of the specimen, the autoclave was opened and the specimen was removed.

The density of the foamed moldings directly after the foaming process was determined by the flotation method, while the cell parameters, such as average cell diameter, were determined via evaluation of scanning electron micrographs of at least two sites, on a cross section produced by cryofracture within the foam. The statistical evaluation utilized images having at least 10 entire cells within the section corresponding to the image.

### Comparative Example 1

Pure PPC was pressed at 120° C. to give a sheet. The temperature set for the exposure to, and the foaming by, CO₂ in the autoclave was 40° C.

The minimum density exhibited by the foamed specimen for the selected exposure and foaming temperature of 40° C. is 272 kg/m³.

### Comparative Example 2

Pure PPC was pressed at 120° C. to give a sheet. The temperature set for the exposure to, and the foaming by, CO₂ in the autoclave was 50° C.

The minimum density exhibited by the foamed specimen for the selected exposure and foaming temperature of 50° C. is 287 kg/m³.

### Comparative Example 3

40% by weight of i-1 (PPC) and 60% by weight of iii-1 were pressed at 170° C. to give a sheet. The temperature set for the exposure to, and the foaming by, CO₂ in the autoclave was 40° C.

The minimum density exhibited by the foamed specimen for the selected exposure and foaming temperature of 40° C. is 141 kg/m³.

### Comparative Example 4

40% by weight of i-1 and 59% by weight of iii-1, and 1% by weight of v-1, were pressed at 170° C. to give a sheet. The temperature set for the exposure to, and the foaming by, CO₂ in the autoclave was 50° C.

The minimum density exhibited by the foamed specimen for the selected exposure and foaming temperature of 50° C. is 166 kg/m³.

TABLE 1
Constitution of comparative examples 1 to 4

| | Comp. i-1 | Comp. iii-1 | Comp. v-1 | Carbon |
|---|---|---|---|---|
| Examples | [% by wt.] | [% by wt.] | [% by wt.] | dioxide |
| Comp. Ex. 1 | 100 | 0 | 0 | 200 bar |
| | | | | T = 40° C. |
| | | | | 24 h |
| Comp. Ex. 2 | 100 | 0 | 0 | 200 bar |
| | | | | T = 50° C. |
| | | | | 24 h |
| Comp. Ex. 3 | 40 | 60 | 0 | 200 bar |
| | | | | T = 40° C. |
| | | | | 24 h |
| Comp. Ex 4 | 40 | 59 | 1 | 200 bar |
| | | | | T = 50° C. |
| | | | | 24 h |

TABLE 2
Characterization of foams:

| | Density | Cell size | |
|---|---|---|---|
| Examples | [kg/m³] | in μm | Appearance |
| Comp. Ex. 1 | 272 | <20 | Smooth surface, |
| | | | good haptic |
| | | | properties |
| Comp. Ex. 2 | 287 | <20 | Smooth surface, |
| | | | good haptic |
| | | | properties |
| Comp. Ex. 3 | 141 | <20 | Smooth surface, |
| | | | good haptic |
| | | | properties |
| Comp. Ex. 4 | 166 | <20 | Smooth surface, |
| | | | good haptic |
| | | | properties |

### Inventive Example 5

20% by weight of i-1 and 80% by weight of ii-1 were melted at a melt temperature of 180° C. in a twin-screw extruder. 6% by weight of carbon dioxide were incorporated by mixing into the melt at a melt temperature of 181° C. The stated amounts in % by weight are based on the entire amount of components i-1 and ii-1.

The melt was conveyed at a throughput of 5 kg/h into a second extruder, in order to cool the melt from 200° C. to 114° C. The melt loaded with blowing agent is conveyed through a perforated die with one hole (diameter of die: 1.7 mm) and with a temperature of 145° C., and the mixture depressurizes instantaneously to give a foamed strand.

The minimum density of the foamed strand is 44 kg/m³.

### Inventive Example 6

20% by weight of i-1 and 80% by weight of ii-1 were melted at a melt temperature of 180° C. in a twin-screw extruder. 8% by weight of carbon dioxide were incorporated by mixing into the melt at a melt temperature of 181° C. The stated amounts in % by weight are based on the entire amount of components i-1 and ii-1.

The melt was conveyed at a throughput of 5 kg/h into a second extruder, in order to cool the melt from 200° C. to 109° C. The melt loaded with blowing agent is conveyed through a perforated die with one hole (diameter of die: 1.7 mm) and with a temperature of 145° C., and the mixture depressurizes instantaneously to give a foamed strand.

The minimum density of the foamed strand is 31 kg/m³.

### Inventive Example 7

20% by weight of i-1 and 80% by weight of ii-1 were melted at a melt temperature of 180° C. in a twin-screw extruder. 10% by weight of carbon dioxide were incorporated by mixing into the melt at a melt temperature of 180° C. The stated amounts in % by weight are based on the entire amount of components i-1 and ii-1.

The melt was conveyed at a throughput of 5 kg/h into a second extruder, in order to cool the melt from 200° C. (transfer pipe) to 114° C. The melt loaded with blowing agent is conveyed through a perforated die with one hole (diameter of die: 1.7 mm) and with a temperature of 145° C., and the mixture depressurizes instantaneously to give a foamed strand.

The minimum density of the foamed strand is 29 kg/m³.

TABLE 3
Constitution of inventive examples 5 to 7

| | Component i-1 | Component ii-1 | Carbon dioxide |
|---|---|---|---|
| Examples | [% by wt.] | [% by wt.] | [% by wt.] |
| Inv. Ex. 5 | 20 | 80 | 6 |
| Inv. Ex. 6 | 20 | 80 | 8 |
| Inv. Ex. 7 | 20 | 80 | 10 |

TABLE 4
Characterization of foams of the invention

| | Minimum density | Cell wall | |
|---|---|---|---|
| Examples | [kg/m³] | thickness in nm | Appearance |
| Inv. Ex. 5 | 44 | <200 | Smooth surface, |
| | | | good haptic |
| | | | properties |
| Inv. Ex. 5 | 31 | <200 | Smooth surface, |
| | | | good haptic |
| | | | properties |
| Inv. Ex. 5 | 29 | <200 | Smooth surface, |
| | | | good haptic |
| | | | properties |

1-12. (canceled)

13. A foam layer based on a biodegradable polyester mixture, comprising
i) from 5 to 49% by weight, based on the total weight of components i to ii, of at least one polypropylene carbonate;
ii) from 51 to 95% by weight, based on the total weight of components i to ii, of polylactic acid;
iii) from 0 to 25% by weight, based on the total weight of components i to v, of a polyester composed of an (x1) aliphatic and/or (x2) aromatic dicarboxylic acid and of an (y) aliphatic diol;
iv) from 0 to 5% by weight, based on the total weight of components i to v, of a copolymer which comprises epoxy groups and which is based on styrene, acrylate, and/or methacrylate; and
v) from 0 to 15% by weight, based on the total weight of components i to v, of additives.

14. The foam layer based on a biodegradable polyester mixture PM, comprising:
i) from 5 to 45% by weight, based on the total weight of components i and ii, of at least one polypropylene carbonate;
ii) from 55 to 95% by weight, based on the total weight of components i to ii, of polylactic acid;
iii) from 1 to 25% by weight, based on the total weight of components i to v, of a polyester composed of an (x1) aliphatic and/or (x2) aromatic dicarboxylic acid and of an (y) aliphatic diol;
iv) from 0.05 to 2% by weight, based on the total weight of components i to v, of a copolymer which comprises epoxy groups and which is based on styrene, acrylate, and/or methacrylate; and
v) from 0.1 to 5% by weight, based on the total weight of components i to v, of additives.

15. The foam layer according to claim 13, wherein component ii is a polylactic acid with a melt volume rate (MVR for 190° C. and 2.16 kg to ISO 1133) of from 2 to 9 ml/10 minutes.

16. The foam layer according to claim 13, wherein component iii is a polyester composed of:
succinic acid, adipic acid, azelaic acid, or sebacic acid as aliphatic dicarboxylic acid (component x1));
terephthalic acid as aromatic dicarboxylic acid (component x2)), and
1,4-butanediol or 1,3-propanediol as diol component (component y).

17. The foam layer according to claim 13, wherein the amount use of component iv is from 0.05 to 2% by weight, based on the total weight of components i to v.

18. The foam layer according to claim 13, wherein an amount of from 0.2 to 3% by weight, based on the total weight of components i to v, of a nucleating agent is used as component v.

19. The foam layer according to claim 13 wherein the layer has a density smaller than 50 g/l.

20. The foam layer according to claim 13, wherein the layer has a thickness of from 0.1 to 100 cm.

21. A process for producing the foam layer according to claim 13, which comprises mixing at from 160 to 220° C. in an extruder or in a masterbatch
A) a biodegradable polyester mixture PM, comprising:
i) from 5 to 50% by weight, based on the total weight of components i to ii, of at least one polypropylene carbonate;
ii) from 50 to 95% by weight, based on the total weight of components i and ii, of polylactic acid;
iii) from 0 to 25% by weight, based on the total weight of components i to v, of a polyester composed of an (x1) aliphatic and/or (x2) aromatic dicarboxylic acid and of an (y) aliphatic diol;
iv) from 0 to 5% by weight, based on the total weight of components i to v, of a copolymer which comprises epoxy groups and which is based on styrene, acrylate, and/or methacrylate; and
v) from 0 to 15% by weight, based on the total weight of components i to v, of additives; and
B) injecting, in the form of a gas under pressure, from 1 to 25% by weight, based on the polymer mixture PM, of a blowing agent, and
C) cooling the mixture and extruding it to give the foam layer, and optionally thermoforming it in a thermoforming apparatus.

22. A process for producing the foam layer according to claim 13, which comprises mixing at from 160 to 220° C. in an extruder or in a masterbatch
A) a biodegradable polyester mixture PM, comprising:
i) from 5 to 45% by weight, based on the total weight of components i to ii, of at least one polypropylene carbonate;
ii) from 55 to 95% by weight, based on the total weight of components i and ii, of polylactic acid;
iii) from 1 to 25% by weight, based on the total weight of components i to v, of a polyester composed of an (x1) aliphatic and/or (x2) aromatic dicarboxylic acid and of an (y) aliphatic diol; and
iv) from 0.05 to 2% by weight, based on the total weight of components i to v, of a copolymer which comprises epoxy groups and which is based on styrene, acrylate, and/or methacrylate; and
v) from 0.1 to 5% by weight, based on the total weight of components i to v, of additives; and
B) injecting, in the form of a gas under pressure, from 1 to 25% by weight, based on the polymer mixture PM, of a blowing agent, and
C) cooling the mixture and extruding it to give the foam layer, and optionally thermoforming it in a thermoforming apparatus.

23. The process according to claim 21, wherein a physical blowing agent is used.

24. A thermal insulation and sound-deadening, or a packaging material which comprises the foam layer according to claim 13.
